(19) United States
(12) Patent Application Publication
(10) Pub. No.: US 2012/0113329 A1
(43) Pub. Date: May 10, 2012

(54) LASER PROJECTOR

(75) Inventor: You-ruei Lin, Tu Cheng (TW)

(73) Assignee: Cheng Uei Precision Industry Co., LTD., Tu Cheng City (TW)

(21) Appl. No.: 12/942,812

(22) Filed: Nov. 9, 2010

(51) Int. Cl. H04N 9/31

(52) U.S. Cl. 348/744; 348/E09.025

(57) ABSTRACT

A laser projector has a cursor control unit, a main control unit, a laser generator and a scanning lens. The cursor control unit is used to generate and transmit cursor signals; the main control unit is used to obtain and process video signals and the cursor signals, both of which are combined into cursor video signals and transmitted; the laser generator is coupled to the main control unit for generating and projecting laser beam according to the cursor video signals; and the scanning lens is coupled to the main control unit for receiving the laser beam and projecting it outward in a predetermined scanning manner. The laser projector of the present invention uses laser resource itself to project laser cursor generated by the cursor control unit onto a screen, so that it is unnecessary to additionally use a laser pointer, and the operation of the laser projector is relatively simple.

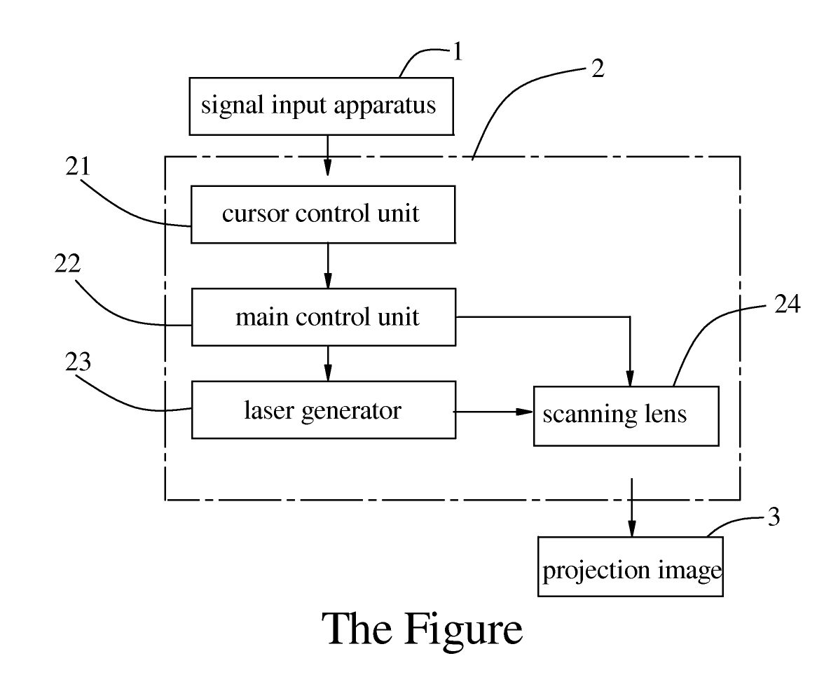

### FIELD OF THE INVENTION

The present invention relates to a projector, and more particularly to a laser projector.

### BACKGROUND OF THE INVENTION

Nowadays, projectors have become common products used by modern business people. In comparison with technologies of digital light processing (DLP) or liquid crystal on silicon (LCoS), a laser projector has advantages of lower power consumption, larger projection images (greater than 100 inches) and no focusing need, the laser projector has become a popular product in human life.

However, when a traditional laser projector is used for speech, a user needs to additionally use a laser pointer for pointing the current content during the speech. If the user forgets to carry the laser pointer or the laser pointer is lost, it will be inconvenient for the user to lecture.

### SUMMARY OF THE INVENTION

A primary object of the present invention is to provide a laser projector, which can avoid from additionally using a laser pointer and is relatively simple, and thus can overcome the disadvantages existing in the conventional technologies, as described above.

To achieve the above object, a laser projector of a preferred embodiment of the present invention comprises a laser projector is provided, and has a cursor control unit, a main control unit, a laser generator and a scanning lens. The cursor control unit is used to generate and transmit real-time mobile cursor signals; the main control unit is used to obtain and process video signals and the cursor signals, and then combine the video signals and the cursor signals into cursor video signals for subsequently transmitting the cursor video signals; the laser generator is coupled to the main control unit for generating and projecting laser beam according to the cursor video signals; and the scanning lens is coupled to the main control unit for receiving the laser beam transmitted from the laser generator and projecting the laser beam outward in a predetermined scanning manner.

As described above, the laser projector of the present invention uses laser resource itself to project a laser cursor generated by the cursor control unit onto a screen, so that it is unnecessary to additionally use a laser pointer, and the operation of the laser projector of the present invention is relatively simple.

### DESCRIPTION OF THE DRAWINGS

The Figure is a block diagram of a laser projector according to a preferred embodiment of the present invention.

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

Referring now to the Figure, a laser projector according to a preferred embodiment of the present invention is illustrated. As shown, a laser projector 2 comprises a cursor control unit 21, a main control unit 22, a laser generator 23 and a scanning lens 24. The cursor control unit 21 is used to generate and transmit real-time mobile cursor signals. The main control unit 22 is used to obtain and process video signals and the cursor signals, and then combine the video signals and the cursor signals into cursor video signals for subsequently transmitting the cursor video signals. The laser generator 23 is coupled to the main control unit 22, and used to generate and project laser beam according to the cursor video signals. The scanning lens 24 is coupled to the main control unit 22, and used to receive the laser beam transmitted from the laser generator 23 and project the laser beam outward in a predetermined scanning manner.

The cursor control unit 21 is preferably a touch panel (not-shown) which can control the cursor signals or a set of control keys (not-shown) which can control the motion and the shape variation of a cursor. Alternatively, the cursor control unit 21 can simultaneously include the touch panel which can control the cursor signals and the set of control keys which can control the motion and the shape variation of a cursor.

Besides, the cursor control unit 21 also can include a receiving portion (not-shown) coupled to the main control unit 22 and a remote control portion (not-shown) coupled to the receiving portion. The remote control portion is installed with a position sensor (not-shown), wherein the remote control portion can detect position variation of the remote control portion by the position sensor and then transmit signals of position variation to the receiving portion.

Referring still to the Figure, an operational flowchart of the laser projector 2 comprises the following steps of:

Inputting signals of the laser projector 2 from a signal input apparatus 1, wherein the signals include video signals and cursor signals;

Obtaining cursor positions in the inputted signals by the cursor control unit 21 of the laser projector 2 through a cursor obtaining software, wherein the cursor obtaining software is then used to modify, combine and construct the cursor positions into new cursor signals, and transmit the new cursor signals to the main control unit 22;

Combining the new cursor signals and the original video signals into cursor video signals by the main control unit 22; and

Projecting the cursor video signals outward in a predetermined scanning manner, so as to form projection images 3 which are video images with a cursor shown on a screen.

The laser projector of the present invention can use the cursor control unit 21 to execute a series of operations to the cursor signals, such as to control the motion of the cursor, or to vary the size and shape of the cursor.

As described above, the laser projector 2 of the present invention uses laser resource itself to project a laser cursor generated by the cursor control unit 21 onto a screen, so that it is unnecessary to additionally use a laser pointer, and the operation of the laser projector of the present invention is relatively simple.

The present invention is not limited to the foregoing preferred embodiment, and the man skilled in the art can carry out many changes and modifications to the described embodiment. For example, except for obtaining signals from an external signal input apparatus 1, the laser projector 2 also can use a built-in reading unit for read signals from other storage device, wherein the changes and modifications thereof are cover by the appended claims.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A laser projector, comprising:
a cursor control unit generating and transmitting real-time mobile cursor signals;
a main control unit obtaining and processing video signals and the cursor signals, and then combining the video signals and the cursor signals into cursor video signals for transmitting;
a laser generator coupled to the main control unit, generating laser beam according to the cursor video signals, and projecting the laser beam; and
a scanning lens coupled to the main control unit, receiving the laser beam transmitted from the laser generator, and projecting the laser beam outward in a predetermined scanning manner.

2. The laser projector according to claim 1, wherein the cursor control unit includes a touch panel which controls the cursor signals.

3. The laser projector according to claim 1, wherein the cursor control unit includes a set of control keys which controls motion of a cursor.

4. The laser projector according to claim 1, wherein the cursor control unit includes a set of control keys which controls shape variation of a cursor.

5. The laser projector according to claim 1, wherein the cursor control unit includes a receiving portion coupled to the main control unit and a remote control portion coupled to the receiving portion, while remote control portion is installed with a position sensor, so that the remote control portion detects position variation of the remote control portion by the position sensor and then transmit signals of position variation to the receiving portion.
